(19) United States
(12) Patent Application Publication
(10) Pub. No.: US 2004/0127352 A1
(43) Pub. Date: Jul. 1, 2004

(54) High hydrothermal stability catalyst support

(75) Inventors: Yaming Jin, Ponca City, OK (US); Rafael L. Espinoza, Ponca City, OK (US)

Correspondence Address: DAVID W. WESTPHAL, CONOCOPHILLIPS COMPANY, P.O. BOX 1267, PONCA CITY, OK, 74602-1267, US

(73) Assignee: ConocoPhillips Company, Houston, TX (US)

(21) Appl. No.: 10/687,017

(22) Filed: Oct. 16, 2003

Related U.S. Application Data
(60) Provisional application No. 60/419,006, filed on Oct. 16, 2002.

(51) Int. Cl. B01J 23/56

(52) U.S. Cl. 502/332

(57) ABSTRACT

Methods are disclosed for preparing hydrothermally-stable structurally-promoted refractory-oxide catalyst supports, which includes mixing precursors of the refractory oxide and of at least one structural promoter and calcining the mixture. The methods feature the incorporation of at least one structural promoter into the lattice of a refractory-oxide material such as alumina. The hydrothermally-stable structurally-promoted refractory-oxide catalyst supports are useful in hydrothermal catalytic processes such as Fischer-Tropsch reactions.

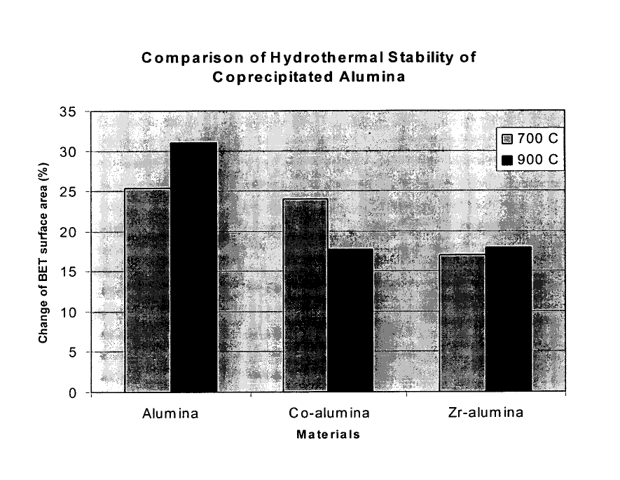

### CROSS-REFERENCE TO RELATED APPLICATIONS

This non-provisional application claims the benefit of U.S. Provisional Application No. 60/419,006, filed Oct. 16, 2002, which is hereby incorporated by reference in its entirety.

### STATEMENT REGARDING FEDERALLY SPONSORED RESEARCH OR DEVELOPMENT

Not Applicable.

### FIELD OF THE INVENTION

The present invention relates to catalyst supports and more specifically to catalyst supports having structural promoters to improve hydrothermal stability.

### BACKGROUND OF THE INVENTION

Catalyzed reactions frequently occur at surfaces—i.e., the surface of the catalyst serves as an active site for the combination or separation of reactive species—and the available surface area therefore limits reaction rates. Consequently, optimal reaction rates are achieved in catalytic processes when the active surface area of the catalyst is maximized, in which the larger the surface area of catalyst results in the greater the number of active sites and the faster the rate of the reaction. One common way to increase effective surface area is to provide the catalytic material, usually a metal, as a thin coating on the surface of a high surface area support material. To achieve this objective, the catalytic metal is commonly deposited on a high surface area catalyst support composed of one or more porous refractory oxides such as silica, alumina, titania, thoria, zirconia and mixtures thereof. Because these support materials provide the structure for the catalyst and thus determine its shape and the amount of surface area per unit volume, the porosity and surface area of the support tend to affect the rate for the catalytic reaction.

In addition to having high surface area, catalyst supports are also desirably robust. Although catalysis generally provides for lower operating process temperatures, many catalyzed reactions nevertheless require high temperatures for acceptable reaction rates. Furthermore, catalyzed reactions commonly involve reactive products, reactants and/or intermediates and elevated pressures. Under these conditions, even inert materials can prove unacceptable. Thus, commercially viable catalyst supports desirably withstand the harsh conditions associated with the process in which they will be employed.

The Fischer-Tropsch reaction is an example of an important catalytic process for which robust catalyst supports are desirable. The Fischer-Tropsch reaction allows the synthesis of hydrocarbons from natural gas. Hydrocarbons serve a number of important purposes and are an invaluable source of gasoline and diesel fuel. Historically, such hydrocarbons have been obtained through drilling and extraction from oil reserves and refining of crude oil. Unfortunately, though, these reserves represent an exhaustible supply that is quickly being depleted. Thus, there is currently great interest in methods capable of converting other natural resources into liquid hydrocarbons.

Natural gas reserves, unlike the dwindling liquid hydrocarbon deposits, are a plentiful resource. In addition, natural gas is itself a useful fuel. However, because the transportation costs for natural gas are relatively high compared to liquid hydrocarbons, the development of many natural gas fields is not commercially feasible. The Fischer-Tropsch reaction is attractive, in part, because conversion of natural gas to liquid hydrocarbons at the well head would not only provide desirable liquid hydrocarbon fuels but also would decrease transportation costs. In short, the Fischer-Tropsch process offers the potential to exploit otherwise unappealing natural gas reserves.

The conversion of natural gas, which is principally methane, to liquid hydrocarbons is typically carried out in two steps. In the first step, methane is converted into a mixture of carbon monoxide and hydrogen, commonly referred to as synthesis gas or syngas. In a second step, the synthesis gas is converted into various hydrocarbons by the Fischer-Tropsch process. Fischer-Tropsch synthesis generally includes contacting a stream of synthesis gas with an appropriate catalyst under temperature and pressure conditions that favor the formation of hydrocarbon products.

Catalysts for the Fischer-Tropsch process typically include a metal selected from the group comprising cobalt, iron, ruthenium, or other Group VIIIA metals; optionally, a cocatalyst selected from the group comprising copper, thorium, zirconium, rhenium or titanium; and, optionally, a promoter selected from the group consisting of the alkali metals, the alkaline earths, the lanthanides, Group IIIB, IVB, VB, VIB or VIIB metals; and may be supported on some carrier or unsupported. The current practice with respect to supported catalysts is to use porous, inorganic refractory oxides as the carrier. γ-Al₂O₃ is an example of such a carrier.

Typically, in the Fischer-Tropsch synthesis, the distribution of weights that is observed such as for C₅₊ hydrocarbons, can be described by likening the Fischer-Tropsch reaction to a polymerization reaction with a Shultz-Flory chain growth probability (α) that is independent of the number of carbon atoms in the lengthening molecule. α is typically interpreted as the ratio of the mole fraction of Cₙ₊₁ product to the mole fraction of Cₙ product. A value of α of at least 0.72 is preferred for producing high carbon-length hydrocarbons, such as those of diesel fractions.

The general chemistry of the Fischer-Tropsch reactions is as follows:

n CO+(2n+1)H₂→CₙH₂ₙ₊₂+n H₂O [1]

The catalytic metal used can influence the nature and composition of the mixture of products obtained from a Fischer-Tropsch catalytic process. Cobalt has been investigated extensively as a catalyst for the production of hydrocarbons with weights corresponding to the range of the gasoline, diesel, and higher weight fractions of hydrocarbons. In particular, cobalt has been found to be suitable for catalyzing a process in which synthesis gas is converted to hydrocarbons having primarily five or more carbon atoms-i.e., where the C₅₊ selectivity of the catalyst is high. See, for example, H. Schulz, Short History and Present Trends of Fischer-Tropsch Synthesis, APPLIED CATALYSIS A, vol. 186, pp. 3-12 (1999), which is hereby incorporated herein by reference in its entirety.

There exists a competing reaction, the water-gas shift reaction, described by equation [2], in which carbon monoxide is consumed in a reaction with water generated from equation [1], above, to form carbon dioxide (CO₂) and hydrogen (H₂).

CO+H₂O→CO₂+H₂[2].

Fischer-Tropsch catalysts have the disadvantage of producing water. Consequently, a water gas shift reaction can occur with the produced water and the CO present. It is well known for example that iron-based Fischer-Tropsch catalysts have some water gas shift activity and that reactors employing such catalysts tend to produce more CO₂ and less water than reactors employing cobalt-based Fischer-Tropsch catalysts, which have a much lower water gas shift activity. Thus, Fischer-Tropsch reactors utilizing a cobalt-based catalyst can generate significant amounts of water. Therefore, the Fischer-Tropsch reaction regime constitutes a harsh environment for catalyst supports, especially when cobalt catalysts are used.

In addition to the copious amounts of water formed when cobalt is used, elevated temperatures are required. Such hydrothermal conditions present several challenges. For example, it is known that the presence of water at high temperatures decreases catalyst activity by oxidizing the catalytic metal. Hydrothermal conditions also cause instability in high surface area supports such as gamma alumina (γ-Al₂O₃). These supports tend to undergo changes that initially reduce catalyst activity and ultimately cause support disintegration, which results in significant levels of catalyst fines in the Fischer-Tropsch product. Overall, the hydrothermal conditions present during Fischer-Tropsch processing not only reduce catalyst activity but also increase Fischer-Tropsch processing costs through the loss of regenerable catalyst as well as increased catalyst/liquid products separation costs.

Alumina supports are typically used for Fischer-Tropsch catalysts and exist in a number of crystallographic phases. γ-Al₂O₃ is a ubiquitous support for many heterogeneous catalytic processes ranging from automotive catalysis to hydrocarbon cracking. γ-Al₂O₃ can be made by the calcination of naturally occurring or synthetic boehmite (α-Al₂O₃.H₂O) through the removal of water and concomitant phase change. Conventional processes can bring about this conversion in ways that result in various types of γ-Al₂O₃ having distinct combinations of properties desirable to specific industries—e.g., particle size, surface area, pore volume and average pore diameter. Nevertheless, Fischer-Tropsch reactors that produce water vapor at high temperature and high partial pressure create an environment that continues to challenge the hydrothermal stability of γ-Al₂O₃ supports. These supports are prone to degradation, fragmentation, and/or other processes that compromise the ability to support catalytic metals. For instance, under Fischer-Tropsch conditions, γ-Al₂O₃ supports typically undergo at least a partial transformation to a lower surface area phase such as boehmite. Such a phase change can cause reduced activity in γ-alumina supported catalysts as well as structural weakness and partial surface degradation. Finding or preparing an alumina support of sufficient hydrothermal stability for use in protracted Fischer-Tropsch reactor runs remains an important problem in the art.

Consequently, there is a need for a method to improve catalyst support stability under hydrothermal conditions. Further needs include an improvement in the economics of reactions occurring with production of water at elevated temperatures, such as Fischer-Tropsch reactions catalyzed by cobalt. Additional needs include a hydrothermally stable catalyst support.

### BRIEF SUMMARY OF SOME OF THE PREFERRED EMBODIMENTS

The preferred embodiments of the present invention encompass methods of preparing catalyst supports that exhibit enhanced hydrothermal stability by incorporating structural promoters into the lattice of a refractory-oxide support.

According to one preferred embodiment, a modified refractory-oxide support is prepared by a method that includes forming a refractory-oxide sol from a refractory-oxide precursor and incorporating one or more structural promoters into the refractory-oxide sol. The method further includes one or more of gelling and precipitating the sol to form a support precursor and calcining the support precursor to form a hydrothermally-stable structurally-promoted refractory-oxide support. The refractory oxide is preferably alumina. Alternatively, the refractory oxide may be chosen from among zirconia, magnesia, titania, alumina, silica, and combinations thereof.

According to another preferred embodiment, a method for preparing a modified refractory-oxide support includes adding one or more structural promoter precursors to a refractory-oxide precursor solution and forming a refractory-oxide sol. The method further includes one or more of gelling and precipitating the sol to form a support precursor and calcining the support precursor to form a high hydrothermal stability refractory-oxide support. The refractory oxide is preferably alumina. Alternatively, the refractory oxide may be chosen from among zirconia, magnesia, titania, alumina, silica, and combinations thereof.

According to yet another preferred embodiment of the present invention, a modified catalyst includes a catalytic metal dispersed on a modified refractory-oxide support according to any one of the above-described embodiments. According to still yet another preferred embodiment of the present invention, a hydrothermal catalytic process includes contacting a feed stream with a modified catalyst according to any one of the above-described embodiments.

Other embodiments include a method for preparing a hydrothermally-stable structurally-promoted refractory-oxide catalyst support comprising forming a refractory-oxide material as a slurry or sol from one or more refractory-oxide precursors; adding one or more structural promoter precursors to the refractory-oxide material; and calcining the refractory-oxide material to obtain the hydrothermally-stable structurally-promoted refractory-oxide catalyst support. The hydrothermally-stable structurally-promoted refractory-oxide catalyst support can be a modified transition alumina support.

In another embodiment, the present invention includes a Fischer-Tropsch catalyst comprising a hydrothermally-stable structurally-promoted refractory-oxide catalyst support; and a catalytic metal effective in catalyzing a Fischer-Tropsch reaction.

It will therefore be seen that a technical advantage of the present invention is the incorporation of structural promoters to the lattice structure of catalyst supports, thereby eliminating problems encountered with conventional high surface area supports. For instance, problems with hydrothermal instability are overcome. Further advantages include blocking or retarding the phase transformation of an alumina (such as gamma-alumina) to a lower surface area phase (such as boehmite).

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a detailed description of the preferred embodiments of the invention, reference will now be made to the accompanying drawing in which the drawing illustrates a comparison of the hydrothermal stability of supports.

### DETAILED DESCRIPTION OF THE PREFERRED EMBODIMENTS

It has been discovered that catalyst supports prepared by having structural promoters incorporated directly in the lattice of a refractory-oxide precursor reinforce the lattice structure, thereby enhancing stability of the lattice structure under hydrothermal conditions. It has been further discovered that the structural promoters retard an undesired phase change that may occur under hydrothermal conditions. For instance, it has been further discovered that, under exemplary hydrothermal conditions, gamma alumina (γ-Al₂O₃) undergoes at least a partial transformation to a lower surface-area phase, in particular boehmite. Structural analysis reveals that the boehmite phase formed from γ-Al₂O₃ under hydrothermal conditions is a crystalline boehmite comprising planar primary particles having dimensions of at least 20 nm. This contrasts with γ-Al₂O₃, which typically has a primary particle size of about 5 nm. It is believed that this phase change not only leads to reduced activity of a catalyst supported on γ-Al₂O₃ and used in a catalytic processes under hydrothermal conditions but also may cause structural weakness and partial surface disintegration. Thus, inhibition of this phase transformation is desirable for catalyst supports for reactions that involve high water vapor partial pressures and high temperatures, such as Fischer-Tropsch reactions. Such an undesired phase change has been discovered to be retarded by incorporation of the structural promoters according to the present invention.

In a preferred embodiment, a catalyst support is prepared by a method comprising combining one or more refractory-oxide precursors with one or more structural promoter precursors to yield a precursor mixture; forming a support precursor from the precursor mixture; and calcining the support precursor to obtain a hydrothermally-stable structurally-promoted refractory-oxide catalyst support, wherein the catalyst support comprises the hydrothermally-stable structurally-promoted refractory-oxide catalyst support.

It is to be understood that the present invention is applicable to any refractory-oxide support comprising refractory-oxide materials susceptible to phase changes during catalyzed reactions involving hydrothermal conditions. Suitable refractory-oxide materials include alumina, zirconia, magnesia, silica, titania, or combinations thereof. The refractory-oxide materials can be formed from refractory-oxide precursors of the refractory-oxide materials. Refractory-oxide precursors of the refractory-oxide materials are well known and can include any suitable precursor for forming refractory-oxide supports. The example of alumina in the Fischer-Tropsch reaction is but one example of such a support and such a reaction. Therefore, without limiting the scope of the invention, the preferred embodiments of the present invention are directed to alumina. The alumina can be formed from alumina precursors. Alumina precursors can include aluminum alkoxides and inorganic precursors such as aluminum nitrate, aluminum sulfate, sodium aluminate, and aluminum chloride.

The structural promoters of the present invention include any elements suitable for fortifying the lattice structure of a refractory-oxide material. Suitable structural promoters include tungsten (W), tantalum (Ta), niobium (Nb), thorium (Th), germanium (Ge), uranium (U), tin (Sn), antimony (Sb), vanadium (V), halfnium (Hf), sodium (Na), potassium (K), boron (B), magnesium (Mg), silicon (Si), calcium (Ca), titanium (Ti), chromium (Cr), manganese (Mn), iron (Fe), cobalt (Co), nickel (Ni), copper (Cu), zinc (Zn), gallium (Ga), strontium (Sr), zirconium (Zr), barium (Ba) and the lanthanides, including lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), yterrbium (Yb) and lutetium (Lu).

The structural promoters can also be provided as a structural promoter precursor. A structural promoter precursor can be any precursor of the structural promoter that facilitates the incorporation of the structural promoter into the lattice of the refractory-oxide catalyst support. Without limiting the scope of the invention, the structural promoter precursors of the present invention include the salts, oxides, acids, hydroxides and the like, of the structural promoters. Without limiting the invention, examples of salts include nitrates, acetates, and acetylacetonates.

Precursors in which the structural promoter element is in a valence (oxidation) state of +2, +3, +4, or +5 are preferred. More preferably, any vanadium that is contained in the structural promoter precursor is preferably in the +5 oxidation state; any silicon, titanium, zirconium, or magnesium that is contained in the structural promoter precursor is preferably in the +4 oxidation state; any boron, iron, tantalum, or lanthanide that is contained in the structural promoter precursor is preferably in the +3 oxidation state; and any zinc, magnesium, cobalt, copper, or nickel that is contained in the structural promoter precursor is preferably in the +2 oxidation state.

At least one of these structural promoter precursors, or a combination thereof, is combined with a refractory oxide precursor in an amount such that the final weight of structural promoter ranges from about 0.1 percent to about 30 percent by weight of the final catalyst support. More preferably, the amount of structural promoter precursor is added in an amount such that the final weight of structural promoter ranges from about 1 percent to about 20 percent by weight of the final catalyst support. Most preferably, the amount of structural promoter precursor is added in an amount such that the final weight of structural promoter ranges from about 1 percent to about 10 percent by weight of the final catalyst support. As used herein, the term structurally promoted refers to a support material into which at least one structural promoter has been incorporated.

Hydrolysis Reactions

According to some preferred embodiments of the present invention, the refractory oxide includes alumina. Several routes to conventional aluminas from alumina precursors are well known and can be adapted to the present invention. One common method for synthesizing activated aluminas from aluminum precursors involves the hydrolysis of an aluminum alkoxide as represented by equation [3]:

2Al(OR)₃+xH₂O→Al₂O₃.(x−3)H₂O+6ROH [3],

wherein R represents the alkyl group of the starting alkoxide and x represents the stoichiometric amount of water. Without limiting the scope of the invention, representative examples of suitable aluminum alkoxide precursors include aluminum trimethoxide, aluminum triethoxide, aluminum tri-t-butoxide, and aluminum tri-s-butoxide. Preferably, all three alkoxide groups in the alkoxide are the same. More preferably, all three alkoxides are secondary or tertiary alkoxides.

The hydrolysis reaction is preferably performed in a large excess of water so that the resulting aqueous slurry is about nine to about fifteen percent alumina by weight. The hydrolysis is preferably performed at a temperature of between about 30° C. and about 110° C. More preferably, the hydrolysis is performed at a temperature from about 60° C. to about 100° C. Depending upon their miscibility with water, the resulting alcohols form a second phase that can be decanted from the aqueous slurry. The aqueous slurry can then be filtered, dried and calcined to yield a dry alumina powder.

Precipitation Processes

Another well-known route to aluminas involves the precipitation of alumina and aluminum hydroxides from aluminum salts, typically under basic conditions. A representative example is the reaction of aluminum chloride with ammonium hydroxide to yield alumina and ammonium chloride, as represented by equation [4]:

2AlCl₃+6NH₄OH→Al₂O₃.3H₂O+6NH₄Cl [4].

As used herein, the term precipitation agent refers to a chemical agent that affects the precipitation of a refractory oxide from a refractory-oxide precursor. In equation [4] above, the precipitation agent is ammonium hydroxide, the refractory-oxide precursor is aluminum chloride, and the refractory oxide is alumina. A variety of aluminum salts can serve as alumina precursors. Therefore, without limiting the scope of the invention, representative examples of alumina precursors include inorganic salts such as aluminum nitrate, aluminum sulfate, sodium aluminate and aluminum chloride. The foregoing class of procedures are referred to collectively herein as precipitation processes.

According to one preferred embodiment of the present invention, a precipitation process is modified by adding an appropriate amount of an appropriate structural promoter precursor to the alumina precursor prior to precipitation. Preferably, the precipitation agent affecting a precipitation of the alumina from the alumina precursor also effects a precipitation of the structural promoter from the structural promoter precursor. Such reactions—i.e., those involving the precipitation of both the alumina and the structural promoter from the alumina precursor and the structural promoter precursor, respectively-will be referred to herein as co-precipitation processes.

Sol-Gel Formation

Preferably, the alumina support can be prepared by the sol-gel methods described below. An alumina sol generally refers to a colloidal suspension of alumina particles that can be gelled and processed to form a powder. Sol-gels can be formulated from various inorganic materials including silica, alumina, titania, zirconia, magnesia, and many others. Many techniques exist for preparing sol-gels from refractory-oxide slurries, and a person of ordinary skill will recognize that many or all of these techniques can prove satisfactory in the present invention. Consequently, the sol-gel techniques described below are not intended to be limiting.

Alumina sols formed from alumina precursors can be either basic or acidic, and sol-gel formation generally includes an adjustment of pH to between about five and about nine. A variety of acids or bases can be used for this purpose. Therefore, without limiting the scope of the invention, suitable acids include nitric acid, hydrochloric acid, formic acid and acetic acid. Preferably, the acid is nitric acid. Suitable bases include ammonia, potassium hydroxide, and sodium hydroxide. Preferably, the base is ammonia. The amount of acid or base added to the slurry will depend upon the initial pH of the slurry, the alumina content of the slurry, the type of acid or base employed, the total amount of slurry, and other factors. Alternatively, it is also well recognized that sol-gel formation can be accomplished by conducting a hydrolysis reaction of an aluminum alkoxide under acidic conditions, similar to the process described below. Thus, for example, an alumina sol-gel can be obtained through the addition of an aluminum alkoxide to a nitric acid solution under vigorous stirring and elevated temperatures.

Preferably, the acidic slurry is aged at elevated temperatures until it assumes the form of a colloidal sol. The amount of time required to convert the alumina to a colloidal sol varies with the pH, temperature and pressure. Preferably, the temperature is between about 70° C. and about 100° C., and the pressure is approximately ambient pressure. However, a person of ordinary skill in the art will recognize that the optimization of process temperature, pressure and pH are within the ordinary skill in the art. The resulting alumina sol can then be recovered by decantation or any other method well known to those skilled in the art and further dried and calcined according to well known processes to obtain a final alumina product. The foregoing class of procedures are referred to collectively herein as sol-gel processes. The calcination will be described below following the description of methods for forming the alumina slurry.

According to one preferred embodiment, a sol-gel process is modified by adding a suitable amount of a suitable structural promoter precursor to the alumina sol prior to gel formation. According to another preferred embodiment, a sol-gel process is modified by adding a suitable amount of a suitable structural promoter precursor to the alumina sol following gel formation. Both embodiments are performed to incorporate the structural promoter into the lattice of the alumina support as the lattice is being formed. Preferably, the structural promoter precursor or precursors are hydrolyzed as the alumina precursor or precursors are hydrolyzed. Such reactions—i.e., those involving the hydrolysis of both the alumina precursor or precursors and the structural promoter precursor or precursors—will be referred to herein as co-hydrolysis processes.

Calcining and Post-Processing

Following the modified sol-gel process or modified precipitation process, the modified alumina material can be spray-dried to produce particles. Optionally, the product of the sol-gel process or precipitation process or spray-dried process, can be calcined according to well known procedures to remove water and to form a stabilized hydrothermally-stable Al₂O₃ support material. Preferably, the calcination takes place at a temperature of between about 400° C. and about 900° C. More preferably, the calcination takes place in air at a temperature of between about 450° C. and about 850° C.

Optionally, the product of the sol-gel process or precipitation process is subjected to a steam treatment prior to calcination. As used herein, a mild steam treatment refers to a water vapor treatment at a temperature of about 220° C. and with a water partial pressure of less than 5 bar absolute. In contrast, a high steam treatment refers to a water vapor treatment at a temperature of higher than about 220° C. and/or a water partial pressure in excess of 5 bar absolute.

Following the calcination step, the product support exhibits hydrothermal stability. Hydrothermal stability refers to the ability to withstand sustained conditions of elevated temperature and high water partial pressure. As used herein, the term hydrothermally-stable refers to catalyst supports that undergo less than a twenty percent change in surface area when subjected to water partial pressures in excess of 5 bars absolute at temperatures of greater than 220° C. for periods of time in excess of 2 hours.

Catalysts

The preferred embodiments of the present invention include catalysts, especially Fischer-Tropsch catalysts, employing the hydrothermally-stable structurally-promoted refractory-oxides of the present invention. These catalysts can be prepared from conventional techniques employing the hydrothermally-stable structurally-promoted supports such as those described in the preferred embodiments above. Conventional methods of making catalysts include, for example, impregnation of a support with a solution containing at least one precursor of a catalytic metal, referred to herein as a catalyst precursor, and optionally at least one precursor of a catalytic promoter, referred to herein as a catalyst promoter precursor, followed by drying the impregnated support and preferably followed by calcinations in air.

The catalytic metal is preferably a Fischer-Tropsch catalytic metal. In particular, the catalytic metal is preferably selected from among the Group VIIIA metals, such as iron (Fe), ruthenium (Ru), and osmium (Os), cobalt (Co), rhodium (Rh), and iridium (Ir), nickel (Ni), palladium (Pd), and platinum (Pt), and the metals molybdenum (Mo), rhenium (Re), and tungsten (W), and mixtures thereof. The catalytic metal more preferably comprises Co, Ni, Fe, Ru, or combinations thereof. More preferably, the catalytic metal is selected from among cobalt, iron and mixtures thereof. The catalyst preferably contains a catalytically effective amount of the catalytic metal. The amount of catalytic metal present in the catalyst can vary widely.

Preferably, the catalyst precursor comprises cobalt. The loading of the catalytic metal and any optional promoter on the support can proceed by multistep impregnation, such as by two or three impregnation steps. Preferably, impregnation proceeds by the known methods of incipient wetness using a minimal amount of solvent. The solvent can be water or an organic solvent, such as but not limited to ethanol or acetone, depending on the solubility of the catalyst and/or catalyst promoter precursor or precursors used. Further, each catalyst and/or catalyst promoter precursor can be dissolved in a different solvent before combining the solutions for impregnation. Each step of impregnating the support to form a catalyst is preferably followed by air drying the catalyst. Preferably, the catalyst is then calcined in air. The calcination is preferably performed between about 200 C.° and about 900° C., at a pressure between about 1 (101 kPa) and about 10 atm (1,010 kPa) for a duration of 0.5 to 36 hours.

Fischer-Tropsch catalyst systems often employ one or more catalytic promoters in conjunction with the principal catalytic metal. A catalytic promoter typically improves a measure of the activity of a catalyst, such as activity, selectivity, stability, reducibility or regenerability. Although the same chemical species can serve as both a catalytic promoter and a structural promoter, the purpose of a catalytic promoter generally involves its presence on the surface of the catalyst support alongside a catalytic metal whereas the purpose of a structural promoter generally involves its presence in the lattice of the catalyst support. Catalytic promoters can include Re, Na, K, Rb, Cs, Mg, Ca, Sr, Ba, Cu, Ag, Au Sc, Y, La, Ti, Zr, Hf, V, Nb, Ta, Pd, Rh, Os, Ir, Pt, Mn, B, P, Ru, and combinations thereof. More preferably, the catalytic promoter comprises platinum, ruthenium, copper, silver, boron, and phosphorous. For cobalt-based Fischer-Tropsch catalysts, catalytic promoters preferably include ruthenium, rhenium, platinum and combinations thereof.

Catalytic Processes

Another preferred embodiment of the present invention includes the use of a catalytic metal disposed on a structurally-promoted hydrothermally-stable refractory-oxide catalyst support in a reaction involving hydrothermal conditions. Preferably, the reaction involving hydrothermal conditions is a Fischer-Tropsch reaction employing cobalt as a catalytic metal on a structurally-promoted hydrothermally-stable refractory-oxide catalyst support. Operation conditions can depend on the reactor type, the composition of the catalyst, and like variable of the reactor system. Selection of suitable operation conditions is within the skill of one of ordinary skill in the art.

The feed gases charged to the Fischer-Tropsch process comprise hydrogen, or a hydrogen source, and carbon monoxide. H₂/CO mixtures suitable as a feedstock for conversion to hydrocarbons according to the process of this invention can be obtained from light hydrocarbons such as methane by means of steam reforming, partial oxidation, or other processes known in the art. Preferably, the hydrogen is provided by free hydrogen, although some Fischer-Tropsch catalysts have sufficient water gas shift activity to convert some water and carbon monoxide to hydrogen and carbon dioxide for use in the Fischer-Tropsch process. It is preferred that the molar ratio of hydrogen to carbon monoxide in the feed be greater than 0.5:1 (e.g., from about 0.67 to 2.5). Preferably, when cobalt, nickel, and/or ruthenium catalysts are used, the feed gas stream contains hydrogen and carbon monoxide in a molar ratio of about 1.6:1 to 2.3:1. Preferably, when iron catalysts are used the feed gas stream contains hydrogen and carbon monoxide in a molar ratio between about 1.4:1 and 2.3:1. The feed gas can also contain carbon dioxide. The feed gas stream should contain only a low concentration of compounds or elements that have a deleterious effect on the catalyst, such as poisons. For example, the feed gas may need to be pretreated to ensure that it contains low concentrations of sulfur or nitrogen compounds such as hydrogen sulfide, ammonia, hydrogen cyanide, and carbonyl sulfides.

The feed gas is contacted with the catalyst in a reaction zone. Mechanical arrangements of conventional design can be employed as the reaction zone including, for example, fixed bed, fluidized bed, slurry bubble column or ebulliating bed reactors, among others. Accordingly, the preferred size and physical form of the catalyst particles can vary depending on the reactor in which they are to be used.

The Fischer-Tropsch process is typically run in a continuous mode. In this mode, the gas hourly space velocity through the reaction zone typically can range from about 50 to about 10,000 hr⁻¹, preferably from about 300 hr⁻¹ to about 2,000 hr⁻¹. The gas hourly space velocity is defined as the volume of reactants per time per reaction zone volume. The volume of reactant gases is at standard conditions (standard pressure of 101 kPa and standard temperature of 0° C.). The reaction zone volume is defined by the portion of the reaction vessel volume where the reaction takes place and which is occupied by a gaseous phase comprising reactants, products and/or inerts; a liquid phase comprising liquid/wax products and/or other liquids; and a solid phase comprising catalyst. The reaction zone temperature is typically in the range from about 160° C. to about 300° C. Preferably, the reaction zone is operated at conversion promoting conditions at temperatures from about 190° C. to about 260° C., more preferably from about 205° C. to about 230° C. The reaction zone pressure is typically in the range of about 80 psia (552 kPa) to about 1,000 psia (6,895 kPa), more preferably from 80 psia (552 kPa) to about 800 psia (5,515 kPa), and still more preferably from about 140 psia (965 kPa) to about 750 psia (5,170 kPa). Most preferably, the reaction zone pressure is from about 250 psia (1,720 kPa) to about 650 psia (4,480 kPa).

The products resulting from the process will have a great range of molecular weights. Typically, the carbon number range of the product hydrocarbons will start at methane and continue to about 50 to 100 carbons or more per molecule as measured by current analytical techniques. The process is particularly useful for making hydrocarbons having five or more carbon atoms, especially when the above-referenced preferred space velocity, temperature and pressure ranges are employed.

The wide range of hydrocarbons produced in the reaction zone will typically afford liquid phase products at the reaction zone operating conditions. Therefore, the effluent stream of the reaction zone will often be a mixed phase stream including liquid and gas phase products. The effluent gaseous stream of the reaction zone can be cooled to condense additional amounts of hydrocarbons and passed into a vapor-liquid separation zone separating the liquid and vapor phase products. The gaseous material can be passed into a second stage of cooling for recovery of additional hydrocarbons. The liquid material from the reaction zone together with any liquid from a subsequent separation zone can be fed into a fractionation column. Typically, a stripping column is employed first to remove light hydrocarbons such as propane and butane. The remaining hydrocarbons can be passed into a fractionation column where they are separated by boiling point range into products such as naphtha, kerosene and fuel oils. Hydrocarbons recovered from the reaction zone and having a boiling point above that of the desired products can be passed into conventional processing equipment such as a hydrocracking zone in order to reduce their molecular weight down to desired products such as middle distillates and gasoline. The gas phase recovered from the reactor zone effluent stream after hydrocarbon recovery can be partially recycled if it contains a sufficient quantity of hydrogen and/or carbon monoxide.

To further illustrate various illustrative embodiments of the present invention, the following examples are provided.

### EXAMPLES

The following examples illustrate the improved hydrothermal stability of some of the preferred embodiments of the present invention. Three different samples were prepared according to the procedure described below: (1) an alumina support, (2) a cobalt-promoted alumina support, and (3) a zirconium-promoted alumina support. To compare the samples, the change in BET surface area for the alumina support after steam treatment with respect to BET surface area before steam treatment was compared to the corresponding change in BET surface area for the cobalt-promoted alumina support and the zirconium-promoted alumina support. The results are presented in the drawing.

As can be seen in the drawing, the cobalt-promoted alumina support and the zirconium-promoted alumina support experience less change in BET surface area than the bare alumina support, indicating increased lattice stability and increased hydrothermal stability relative to the bare alumina support. The zirconia-promoted alumina support appears to offer the best results at both 700° C. and 900° C. calcinations.

Bare Alumina Support

To prepare the bare alumina support, 48.1 g of aluminum nitrate [Al(NO₃)₃.9H₂O] was dissolved in 300 ml deionized water. Under vigorous stirring, precipitation was initiated by adding 1 N NH₃.H₂O to the solution until the pH value reached 8.5. Stirring was continued for another 30 minutes. The precipitate was then separated from the suspension by centrifuging and dried in a 100° C. oven overnight. Different samples of the dried material were then calcined at 700° C. and 900° C., respectively, for 3 hours.

Cobalt-Promoted Alumina Support

To prepare the cobalt-promoted alumina support, 48.1 g of aluminum nitrate [Al(NO₃)₃.9H₂O] and 0.98 g cobalt nitrate [Co(NO₃)₂.6H₂O] were dissolved in 300 ml deionized water. Under vigorous stirring, precipitation was initiated by adding 1 N NH₃.H₂O to the solution until the pH value reached 8.5. Stirring was continued for another 30 minutes. The precipitate was then separated from the suspension by centrifuging and dried in a 100° C. oven overnight. Different samples of the dried material were then calcined at 700° C. and 900° C., respectively, for 3 hours.

Zirconium-Promoted Alumina Support

To prepare the zirconium-promoted alumina support, 48.1 g of aluminum nitrate [Al(NO₃)₃.9H₂O] and 0.51 g zirconyl nitrate [ZrO(NO₃)₂.xH₂O] were dissolved in 300 ml deionized water. Under vigorous stirring, precipitation was initiated by adding 1 N NH₃.H₂O to the solution until the pH value reached 8.5. Stirring was continued for another 30 minutes. The precipitate was then separated from the suspension by centrifuging and dried in a 100° C. oven overnight. Different samples of the dried material were then calcined at 700° C. and 900° C., respectively, for 3 hours.

Steaming Treatment

Each support was treated according to a steam treatment. The steam treatment included conditions of a water partial pressure of 5.5 bar and a temperature of 225° C. for 2 hours. These conditions were similar to typical operating conditions of a Fischer-Tropsch process.

The BET surface area of each support was measure both before and after the steam treatment. Results are presented in the drawing.

The following patent applications filed concurrently herewith are hereby incorporated herein by reference: U.S. patent application Ser. No. ______, Attorney Docket No. 1856-27301, entitled “Fischer-Tropsch Processes and Catalysts Made From a Material Comprising Boehmite”; U.S. patent application Ser. No. ______, Attorney Docket No. 1856-20401, entitled “A Stabilized Transition Alumina Catalyst Support From Boehmite and Catalysts Made Therefrom”; and U.S. patent application Ser/ No. ______, Attorney Docket No. 1856-34101, entitled “Fischer-Tropsch Processes and Catalysts Using Stabilized Supports”.

Should the disclosure of any of the patents, patent applications, and publications that are incorporated herein conflict with the present specification to the extent that it might render a term unclear, the present specification shall take precedence.

As used herein, the term “about” or “approximately,” when preceding a numerical value, has its usual meaning and also includes the range of normal measurement variations that is customary with laboratory instruments that are commonly used in this field of endeavor (e.g., weight, temperature or pressure measuring devices), preferably within ±10% of the stated numerical value.

Although the present invention and its advantages have been described in detail, it should be understood that various changes, substitutions and alterations may be made herein without departing from the spirit and scope of the invention as defined by the appended claims.

What is claimed is:

1. A method for preparing a catalyst support comprising:
(a) combining one or more refractory-oxide precursors with one or more structural promoter precursors to yield a precursor mixture;
(b) forming a support precursor from the precursor mixture; and
(c) calcining the support precursor to obtain a hydrothermally-stable structurally-promoted refractory-oxide catalyst support, wherein the catalyst support comprises the hydrothermally-stable structurally-promoted refractory-oxide catalyst support.

2. The method of claim 1 wherein step (b) comprises hydrolysis of the one or more refractory-oxide precursors.

3. The method of claim 1 wherein step (b) comprises co-hydrolysis of the one or more refractory-oxide precursors and the one or more structural promoter precursors.

4. The method of claim 1 wherein step (b) comprises precipitation of the one or more refractory-oxide precursors.

5. The method of claim 1 wherein step (b) comprises co-precipitation of the one or more refractory-oxide precursors and the one or more structural promoter precursors.

6. The method of claim 1 wherein the precursor mixture comprises a sol and step (b) comprises gelling the sol.

7. The method of claim 1 wherein the support precursor comprises alumina and the one or more refractory-oxide precursors comprise alumina precursors.

8. The method of claim 7 wherein the one or more refractory-oxide precursors are inorganic precursors, wherein the inorganic precursors comprise at least one precursor selected from the group consisting of aluminum nitrate, aluminum sulfate, sodium aluminate, and aluminum chloride.

9. The method of claim 7 wherein the one or more refractory-oxide precursors comprise at least one aluminum alkoxide.

10. The method of claim 7 wherein the hydrothermally-stable structurally-promoted refractory-oxide catalyst support is a modified alumina support.

11. The method of claim 7 wherein the precursor mixture comprises a sol, and wherein step (b) comprises gelling the sol.

12. The method of claim 1 wherein gelling the sol occurs at a temperature between about 70° C. and about 100° C.

13. The method of claim 1 wherein the one or more structural promoter precursors comprise at least one element selected from the group consisting of W, Ta, Nb, Th, Ge, U, Sn, Sb, V, Hf, Na, K, B, Mg, Si, Ca, Ti, Cr, Mn, Fe, Co, Ni, Cu, Zn, Ga, Sr, Zr, Ba, and the lanthanides.

14. The method of claim 1 wherein step (b) further comprises steaming the support precursor.

15. A catalyst comprising a catalytic metal dispersed on the catalyst support prepared by the method of claim 1.

16. The catalyst according to claim 15 wherein the catalytic metal comprises Co, Ni, Fe, Ru, or combinations thereof.

17. A hydrothermal reaction process comprising contacting a feed stream with the catalyst of claim 16.

18. The process according to claim 17 wherein the feed stream comprises synthesis gas and the catalytic metal comprises cobalt.

19. The process of claim 18 further comprising converting at least a portion of the synthesis gas to hydrocarbons.

20. A method for preparing a hydrothermally-stable structurally-promoted refractory-oxide catalyst support comprising:
(a) forming a refractory-oxide material as a slurry or sol from one or more refractory-oxide precursors;
(b) adding one or more structural promoter precursors to the refractory-oxide material; and
(c) calcining the refractory-oxide material to obtain the hydrothermally-stable structurally-promoted refractory-oxide catalyst support.

21. The method of claim 20 wherein step (a) comprises hydrolysis of the one or more refractory-oxide precursors.

22. The method of claim 20 wherein step (a) and step (b) comprise co-hydrolysis of the one or more refractory-oxide precursors and the one or more structural promoter precursors.

23. The method of claim 20 wherein step (a) comprises precipitation of the one or more refractory-oxide precursors.

24. The method of claim 20 wherein step (a) and step (b) comprise co-precipitation of the one or more refractory-oxide precursors and the one or more structural promoter precursors.

25. The method of claim 20 wherein step (a) further comprises gelling the refractory-oxide material by a sol-gel process.

26. The method of claim 25 wherein the sol-gel process is conducted at a temperature between about 70° C. and about 100° C.

27. The method of claim 20 wherein step (b) further comprises gelling the refractory-oxide material by a sol-gel process after adding one or more structural promoter precursors to the refractory-oxide material.

28. The method of claim 27, wherein the sol-gel process is conducted at a temperature between about 70° C. and about 100° C.

29. The method of claim 20 wherein the refractory-oxide material comprises alumina and the one or more refractory-oxide precursors comprise an alumina precursor.

30. The method of claim 29 wherein the one or more refractory-oxide precursors comprise at least one precursor selected from the group consisting of aluminum nitrate, aluminum sulfate, sodium aluminate, and aluminum chloride, and wherein the formation of the refractory-oxide material occurs by precipitation of the one or more refractory-oxide precursors.

31. The method of claim 29 wherein the one or more refractory-oxide precursors comprise aluminum alkoxides.

32. The method of claim 29 wherein the hydrothermally-stable structurally-promoted refractory-oxide catalyst support is a modified transition alumina support.

33. The method of claim 29 wherein the one or more structural promoter precursors comprise at least one element selected from the group consisting of W, Ta, Nb, Th, Ge, U, Sn, Sb, V, Hf, Na, K, B, Mg, Si, Ca, Ti, Cr, Mn, Fe, Co, Ni, Cu, Zn, Ga, Sr, Zr, Ba, and the lanthanides.

34. The method of claim 29 wherein step (c) further comprises treating the refractory-oxide material to a steam treatment prior to calcination.

35. The method of claim 29 wherein the calcination takes place at a temperature between about 400° C. and about 900° C.

36. The method of claim 29 further comprising gelling the refractory-oxide material by a sol-gel process before or after the addition of the one or more structural promoter precursors.

37. The method of claim 36 wherein the sol-gel process is conducted at a temperature between about 70° C. and about 100° C.

38. The method of claim 36 wherein the one or more refractory-oxide precursors comprise at least one precursor selected from the group consisting of aluminum nitrate, aluminum sulfate, sodium aluminate and aluminum chloride.

39. The method of claim 36 wherein the one or more refractory-oxide precursors comprise aluminum alkoxides.

40. The method of claim 36 wherein the hydrothermally-stable structurally-promoted refractory-oxide catalyst support is a modified transition alumina support.

41. The method of claim 36 wherein the one or more structural promoter precursors comprise at least one element selected from the group consisting of W, Ta, Nb, Th, Ge, U, Sn, Sb, V, Hf, Na, K, B, Mg, Si, Ca, Ti, Cr, Mn, Fe, Co, Ni, Cu, Zn, Ga, Sr, Zr, Ba, and the lanthanides.

42. The method of claim 36 wherein formation of the refractory-oxide material occurs by co-precipitation of the one or more refractory-oxide precursors and the one or more structural promoter precursors.

43. The method of claim 36 wherein the calcination takes place at a temperature of between about 400° C. and about 900° C.

44. A Fischer-Tropsch catalyst comprising
a hydrothermally-stable structurally-promoted refractory-oxide catalyst support; and
a catalytic metal effective in catalyzing a Fischer-Tropsch reaction.

45. The Fischer-Tropsch catalyst of claim 44 wherein the hydrothermally-stable structurally-promoted refractory-oxide catalyst support comprises alumina.

46. The Fischer-Tropsch catalyst of claim 44 wherein the catalytic metal comprises cobalt, nickel, ruthenium, iron, or combinations thereof.

47. The Fischer-Tropsch catalyst of claim 44 further comprising one or more catalytic promoters selected from the group consisting of Re, Na, K, Rb, Cs, Mg, Ca, Sr, Ba, Cu, Ag, Au Sc, Y, La, Ti, Zr, Hf, V, Nb, Ta, Pd, Rh, Os, Ir, Pt, Mn, B, Ru, P, and combinations thereof.

48. The Fischer-Tropsch catalyst of claim 47 wherein the one or more catalytic promoters are selected from the group consisting of platinum, ruthenium, copper, silver, boron, and phosphorous.
